(19) United States
(12) Patent Application Publication
(10) Pub. No.: US 2024/0375112 A1
(43) Pub. Date: Nov. 14, 2024

(54) MICRO-THERMOCYCLER

(71) Applicant: Toby OVERMAAT, Lathum (NL)

(72) Inventor: Toby OVERMAAT, Lathum (NL)

(21) Appl. No.: 18/114,424

(22) PCT Filed: Aug. 24, 2021
(86) PCT No.: PCT/EP2021/073432

§ 371 Date: Feb. 27, 2023

(30) Foreign Application Priority Data
Aug. 25, 2020 (LU) LU102014

(51) Int. Cl. B01L 7/00

(52) U.S. Cl. CPC B01L 7/525; B01L 2200/147; B01L 2300/042; B01L 2300/0887; B01L 2300/18

(57) ABSTRACT

The Invention relates to a micro-thermocycler that comprises at least one micro-reservoir, at least one thermo controlled element, at least one displacement unit and at least one displacement actuating means. The at least one displacement unit comprises either the at least one micro-reservoir or the at least one thermo controlled element(s). The at least one displacement unit can be displaced by means of the displacement actuating means from a first position along a first direction to a second position. The at least one thermo controlled element thermally acts on the at least one micro-reservoir in the first position and wherein the displacement actuating means operatively couple(s) the at least one displacement unit and the other of thermo controlled element(s) or the micro-reservoir(s).

### FIELD

The present invention relates to a micro thermocycler. In particular, the present invention relates to a MEMS temporal thermocycler.

### BACKGROUND

A thermocycler is a device that heats and cools samples repeatedly in cycles at specific temperatures.

A thermocycler may be used for various temperature cycling protocols, however the most commonly used protocols are used for nucleic acid amplification. For example, the polymerase chain reaction (PCR), typically requires the analyte and reagents to be cycled multiple times through three temperature steps, for example denaturation at 94° C., annealing at 50° C., then extension at 72° C. Also, dependent on the cycling protocol, there might only be two or even one temperature step(s). The temperature in the individual steps might be chosen as needed and/or desired.

A thermocycler may be used in various testing applications, which may include: pathogen detection, antigen typing, disease diagnosis, sequencing, and genotyping, etc

The miniaturization of a thermocycler onto a chip, is desirable in order to enable in-field, rapid, low-cost testing. A micro-thermocycler according to this application has a size range of thickness of 1.5 mm to 60 mm, width of 3 mm to 300 mm and a depth of 3 mm to 150 mm. In the case of larger dimensions, traditional manufacturing processes may be used instead of MEMS.

A thermo controlled element in the sense of this application is an element that may produce and/or remove heat by active or passive means in a controlled manner. Examples of thermo-controlled would be thermoelectric elements, resistive elements, radiation elements, etc. In the case of a thermo controlled element working as a cooling element, the thermo controlled element may also comprise of a combination of passive components such as a heat sinks, heat spreaders, or other conductive elements, or active components such as thermoelectric elements or fans, etc. The thermo-controlled element may also act both as a heating element and a cooling element, e.g. in the case that the thermo controlled element is a thermoelectric element (e.g. a TEC). The thermo controlled elements may be integrated into the structure of the micro-thermocycler or be detachable elements. Furthermore, the thermo-controlled elements may be located internal to or external to the micro-reservoir. A thermo-controlled element internal to the micro-reservoir may have the advantage that the micro-reservoir may be already heated or cooled if the micro-reservoir moves from one position to another. Such thermo-controlled element may be positioned below or above the at least one micro-reservoir or in at least one side wall of the micro-thermocycler, adjacent to the micro-reservoir. If a movement along or in a direction is described, it is to be understood that the movement may be vice versa e.g. the opposite direction as well (bidirectional). A direction is to be understood as a path of movement and not unidirectional. Further, if a movement comprises more than one direction, any sequence of movement to come from the starting position to the desired end position is possible and disclosed. That is, the movement may be first entirely along a first direction and subsequently along a second direction or vice versa or in both directions at the same time or alternating partial movements in the respective directions. This also applies mutatis mutandis to a movement in three directions.

According to one aspect of the present application, a micro-thermocycler comprises at least one micro-reservoir, at least one thermo controlled element, at least one displacement unit and at least one displacement actuating means. The at least one displacement unit comprises either the at least one micro-reservoir or the at least one thermo controlled element(s). The at least one displacement unit can be displaced or moved by means of the displacement actuating means from a first position along a first direction to a second position and vice versa. The at least one thermo controlled element thermally acts on the at least one micro-reservoir in the first position. This may be cooling the at least one micro-reservoir and/or a content (e.g. a sample or analyte) in the at least one micro-reservoir. The displacement actuating means operatively couples the at least one displacement unit and the other of thermo controlled element(s) or the micro-reservoir(s). That is, by means of the displacement actuating means the at least one displacement unit can be moved, such that the at least one micro-reservoir and the thermo controlled element(s) can be moved with respect to each other. It is also possible that the at least one micro-reservoir and the thermo controlled element(s) can both be moved with respect to each other.

In other words, the at least one displacement unit is movable between the two positions. The at least one displacement unit may comprise one or more micro-reservoirs or one or more thermo controlled elements. The micro-reservoir(s) or thermo controlled element(s) may be positioned such that it/they is/are protruding from, or recessed into the at least one displacement unit. The thermo controlled element(s) are meant to thermally act on the one or more micro-reservoirs in an alternating manner such that either the one or more micro-reservoirs move and thus are subjected to changing thermal conditions or the one or more thermo controlled elements move. It is also possible that the thermo controlled elements and the one or more micro-reservoirs move with respect to each other. Such movement or displacement is driven by the at least one displacement actuating means which may be e.g. an actuator or the coupling to an external actuator. The displacement actuating means may be implemented by various means of force, such as electrostatic-, piezoelectric-, electromagnetic-, or thermal-force. Besides the actuation of motion, the displacement actuating means may also act upon the at least one displacement unit in other manners, e.g. motion attenuation, and sag compensation.

Such micro-thermocycler may have the advantage that a content of the micro-reservoir may be subjected to quick changing thermal conditions. For example, in the first position a content of the micro-reservoir can be heated or cooled and then the micro-reservoir moved to the second position in order to cool (e.g. actively or passively) or heat (e.g. by ambient temperature in case of previous cooling) the content of the micro-reservoir. For example, the micro-reservoir and the first thermo controlled element at least partially overlap in the first position. An overlap may be in any orientation of the first thermo controlled element and the micro-reservoir. There may be more than one displacement units each comprising one or more micro-reservoirs and/or one or more thermo-controlled elements. The one or more displacement units may be displaced or moved by one or more displacement actuating means. That is, one displacement actuating means may displace one or more displacement units or multiple displacement actuating means displace multiple displacement units or any other combination thereof.

According to another aspect of the present application, a micro-thermocycler further comprises a second thermo controlled element and wherein the second thermo controlled element thermally acts on the at least one micro-reservoir in the first or second position. The second thermo controlled element may also be comprised by the displacement unit. In other words, the first thermo controlled element and/or the micro-reservoir move to the first position in which the first thermo controlled element thermally acts on the micro-reservoir. The second thermo controlled element and/or the micro-reservoir move to the second position in which the second thermo controlled element thermally acts on the micro-reservoir. For example, the micro-reservoir and the first thermo controlled element at least partially overlap in the first position and the micro-reservoir and the second thermo controlled element at least partially overlap in the second position. An overlap may be in any orientation of the thermo controlled element(s) and the micro-reservoir.

This may have the advantage that for example the first thermo controlled element heats a content of the micro-reservoir and the second thermo controlled element cools the content of the micro-reservoir. This enables for rapid temperature changes of a content of the micro-reservoir. This further may have the advantage that the temperature of the unoccupied position may be prepared. That is for example, if the micro-reservoir and/or the first thermo controlled element are in the first position, the second thermo controlled element may be pre-heated or pre-cooled and vice versa.

The micro-thermocycler may comprise the second thermo controlled element at the same position as the first thermo controlled element, for example the first position. The second thermo controlled element may be vertically stacked with the first thermo controlled element, or adjacent to each other in the same plane as the first thermo controlled element. The thermo controlled elements may also be arranged interlocking. This may have the advantage that both cooling and heating to be achieved in the position, the thermo-controlled elements are located in, is enabled. For example, the first thermo controlled element acts on the micro-reservoir in the first position, after which the reservoir or the micro-reservoir are moved to the second position. The reservoir or the micro-reservoir are then moved back to the first position, where the second thermo controlled element acts on the micro-reservoir.

According to another aspect of the present application, a micro-thermocycler further comprises at least one retaining structure, wherein the at least one retaining structure retains the at least one displacement unit and comprises at least one micro-mechanical structure. The micro-mechanical structure(s) may comprise of one or more of a combination of micro-mechanical elements, e.g. suspension elements, flexible elements, motion guides, stabilization elements, pivots, and/or motor elements. This may have the advantage that the displacement of thermo controlled elements and/or the micro-reservoir may be controlled more precisely.

According to another aspect of the present application, a micro-thermocycler further comprises a third position and/or a fourth position. In the third position the at least one micro-reservoir is accessible via at least one connector port, allowing matter to be transferred to or from the micro-reservoir(s). The fourth position is a transport position of the displacement unit(s). This may have the advantage that matter can be transferred to and from the micro-reservoir in a defined way, by active or passive means (for example by mechanical elements, fluidic systems, pumps, or manual manipulation), and the movable displacement unit can be kept in a dedicated position if the micro-thermocycler is to be moved in order to prevent damage of the micro-thermocycler.

According to another aspect of the present application, a micro-thermocycler further comprises at least one readout sensor that is adapted to sense a content of the at least one micro-reservoir. The at least one readout sensor is located internal to the micro-reservoir or at a defined position external to the micro-reservoir(s). The content(s) of the micro-reservoir(s) is/are detectable by displacement of the micro-reservoir(s) and/or the at least one readout sensor. This may have the advantage that a content of the at least one micro-reservoir may be analyzed regarding desired characteristics. The characteristics for detection and/or monitoring may include fluorescence, light, color, impedance, electrical charge, or other visual-, chemical-, or electrical-signals. There can be multiple readout sensors, stationary and/or moving. Readout sensors may make use of various methods, for example optical detection, electrostatic detection, and/or electrochemical detection. Sensors may detect a single characteristic or multiple characteristics of the micro-reservoir simultaneously. In the case that the readout sensor(s) require additional circuitry or components, e.g. fluorescence excitation diodes, this is to be understood as included in the definition of the readout sensor.

According to another aspect of the present application, the at least one displacement unit is displaceable in a second direction that is different to the first direction, e.g. perpendicular to the first direction. The different positions are reachable by displacement of the at least one displacement unit in at least one of the directions. This has the advantage that the positions may spatially be separated better from each other, improving the reliability of the functionality at each position, e.g. improved readout or thermal transfer. This may have further the advantage of reducing the influence of one position to another.

According to another aspect of the present application, the at least one displacement unit is lockable in at least one of the positions. This may have the advantage that the positioning and/or thermal transfer by the thermo controlled element(s) is more precise and more reliable and/or the transport of the micro-thermocycler is more secure.

According to another aspect of the present application, the micro-thermocycler is a flat three-dimensional structure, that comprises one or multiple surfaces. The multiple surfaces are stacked surfaces. This may have the advantage that the micro-thermocycler can be further miniaturized. This may have further the advantage that manufacturing of the micro-thermocycler could be more easily standardized. Flat in the sense of this application is a structure that extends in three dimensions, however, in one of said dimensions considerably less than in the other two.

According to another aspect of the present application, the displacement along at least one of the directions is a rotational and/or linear motion. This may have the advantage that the design of the micro-thermocycler may be adapted to different system sizes or shapes.

According to another aspect of the present application, the micro-thermocycler further comprises at least one thermal sensor located internal and/or external to the micro-reservoir(s), being adapted to sense temperature(s) at specific locations within the micro-thermocycler. This may have the advantage that the temperature of the content in the micro-reservoir(s) may be known and measured continuously or at specific time points. The thermal sensor(s) may be integrated into the structure of the micro-thermocycler or be detachable elements.

According to another aspect of the present application, at least one aperture is located in the vicinity of the thermo controlled element(s) and/or the at least one micro-reservoir and wherein the at least one aperture is a cavity and/or a groove. The groove and/or cavity may be a through hole(s) or a blind hole(s). The aperture(s) may be filled with air and/or insulative materials. This may have the advantage that there is better isolation of the at least one micro-reservoir or thermo-controlled element(s) from the temperature of the surrounding structures and/or environment. This may have the further advantage that a time can be shortened until a content of the micro-reservoir has received a desired temperature treatment. This may have the further advantage that there is better thermal flow from the thermo controlled elements to the micro-reservoir.

According to another aspect of the present application, the at least one micro-reservoir further comprises an openable cap. This may have the advantage that a content is better contained during the displacement of the micro-reservoir. Further, the content is also better shielded from outside contamination. The cap may be implemented as a movable element(s), or as a passive opening, however, in the case of a passive opening, the cap is considered to be part of the micro-reservoir.

According to another aspect of the present application, at least one of the micro-reservoir and/or the thermo controlled element(s) comprise material coatings to improve thermal and/or reaction characteristics. This may include coatings to enhance thermal conductivity, or coatings to prevent reaction liquid from cross-reacting with the substrate. Coatings may be applied on the side(s) of the micro-reservoir(s) that are in contact with the sample and the thermo controlled element(s) or on underside(s). The underside(s) may be the side of the at least one micro-reservoir, that the thermo-controlled element(s) thermally act on. The underside(s) may further be the undersides of the at least one thermo-controlled element, that is the side of the element that is not hot or cold. This may have the advantage that a time can be shortened until a content of the micro-reservoir has received a desired temperature treatment. This may have the further advantage that the thermal transfer and/or the operation of the micro-thermocycler is more efficient and/or reliable because the coating may be applied to prevent reaction with the material of the micro-reservoir.

According to another aspect of the present application, an inside of the at least one micro-reservoir comprises at least one profiled surface. This may include a structured surface profile to increase surface area. This may have the advantage that a time can be shortened until a content of the micro-reservoir has received a desired temperature treatment. This may have the further advantage that the thermal transfer and/or the operation of the micro-thermocycler is more efficient and/or reliable.

According to another aspect of the present application, the micro-thermocycler further comprises control and/or sensor signals that can be dynamically controlled and/or pre-programmed. The elements that may be controlled or read by these signals include any of the active elements, e.g., the thermo-controlled elements, the readout sensors, the thermal sensors, the displacement actuation means, the openable cap, and the locking mechanisms. This may have the advantage that various thermal cycling protocols may be achieved with a single device. Components to achieve the control or readout of the micro-thermocycler, e.g. control circuitry, computing units, power control, memory, and/or display units, may be integrated within the micro-thermocycler, or be externally connected.

According to another aspect of the present application, the micro-thermocycler further comprises at least one position sensor. The position sensor detects the position of the at least one displacement unit within the micro-thermocycler. The position sensor may be either integrated into the micro-thermocycler or a detachable element to the micro-thermocycler. It may also be implemented using the elements comprising the displacement actuation means. That is, the position sensor can be an independent component or it can be for example a separate frequency signal within the displacement actuation means.

According to an aspect of the present application, a reaction method comprises the steps of placing a sample and reaction materials into at least one micro-reservoir, moving the micro-reservoir from a first position to a second position, heating or cooling the sample at the positions according to a predetermined procedure. This may have the advantage that the sample of the micro-reservoir may receive a thermal treatment in an efficient manner.

According to another aspect of the present application, the position that is not occupied by the micro-reservoir(s) is/are pre-heated or pre-cooled. This may have the advantage that a time between sequential thermal treatment steps of the sample in the micro-reservoir may be shortened.

According to another aspect of the present application, the properties of the sample may be detected continuously or at specific time points. This may have the advantage that the characteristics of the sample may be detected automatically within the micro-thermocycler, rather than by manual operations external to the micro-thermocycler. This may have the further advantage that a time needed to detect a desired characteristic of the sample may be shortened and/or detected in real-time.

According to another aspect of the present application, the heating and/or cooling is cyclic. This may have the advantage that repeating cycles of temperature treatment steps may be performed on the contents of the micro-reservoir.

According to another aspect of the present application, the heating and/or cooling is dynamically controlled by variable signals and wherein the variable signals are generated taking temperature readings into account. This may be implemented as a control loop, for example a proportional-integral-derivative (PID) controller. This may have the advantage that the thermal control element(s) may be controlled more precisely.

According to another aspect of the present application, a computer program adapted to be used with an additive manufacturing device comprises instructions which cause, when the program is executed by the additive manufacturing system, the production of a micro-thermocycler according to one of the above aspects by the additive manufacturing device. This may have the advantage that the micro-thermocycler may be manufactured more easily.

Furthermore, the present invention has a scalable architecture, and may be scaled smaller, scaled larger, or tuned in various configurations in order to achieve improved performance and/or functionality.

The present invention may be configured to be used in disposable and/or reusable applications.

The present invention may be produced using any combination of techniques, including but not limited to: semiconductor device fabrication, MEMS (micro electro-mechanical system) processes, chip packaging processes, 3D-printing techniques, PCB (printed circuit board) processes, and/or any other means for the purpose of producing small-scale devices.

The invention may be fabricated on any combination of materials, including but not limited to: silicon, glass, polymers, and/or metals.

The invention may be produced as a standalone thermocycler chip/device, or integrated with other functions as an integrated chip or system.

For a better understanding of the invention the latter will be explained in view of the appended figures.

The figures respectively show in very simplified and schematically depiction:

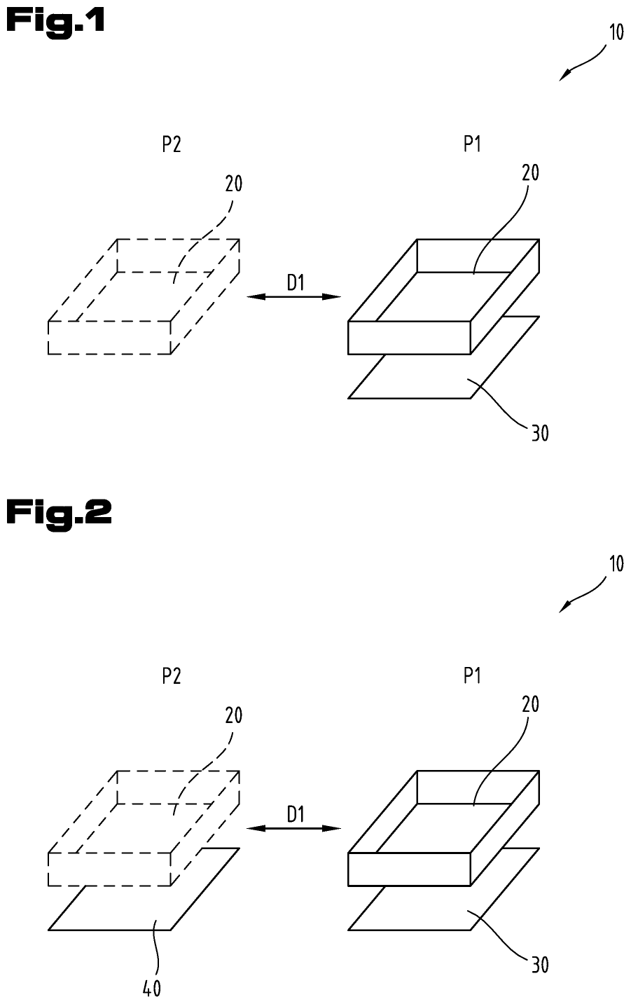

FIG. 1 schematically shows a first embodiment of the present application having one thermal-controlled element.

FIG. 2 schematically shows a second embodiment of the present application having two thermal-controlled elements.

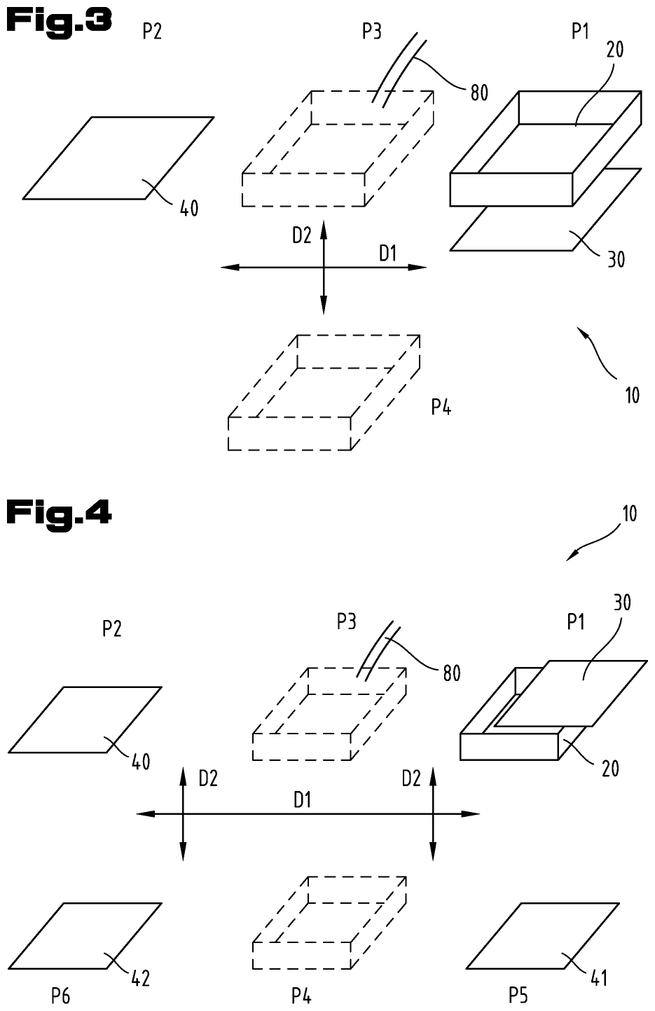

FIG. 3 schematically shows a third embodiment of the present application having four positions.

FIG. 4 schematically shows a fourth embodiment of the present application having six positions.

FIG. 5 schematically shows a fifth embodiment of the present application, similar to FIG. 2.

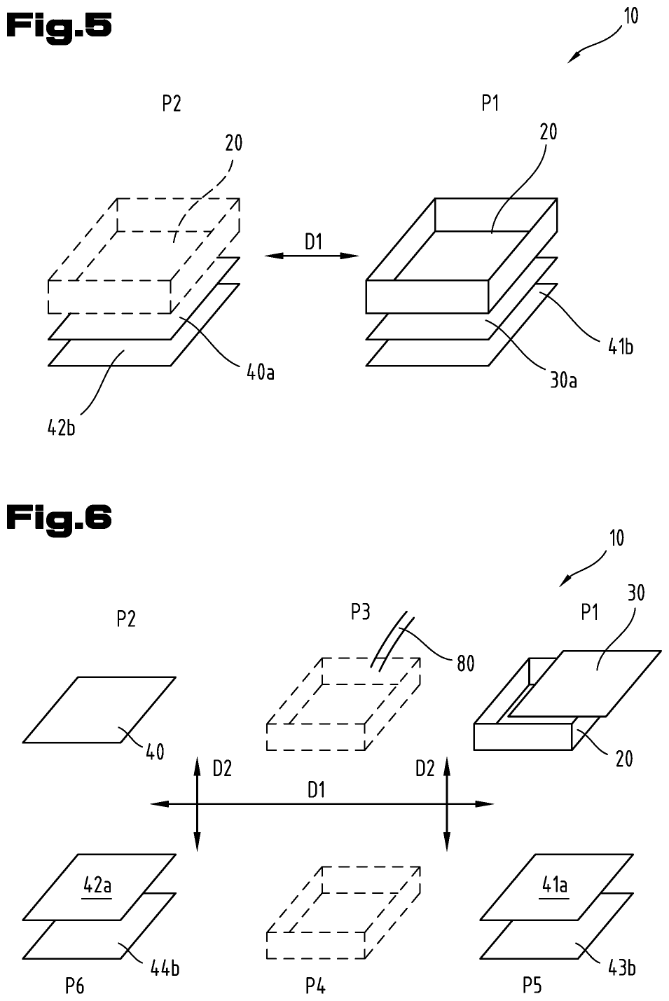

FIG. 6 schematically shows a sixth embodiment of the present application, similar to FIG. 4.

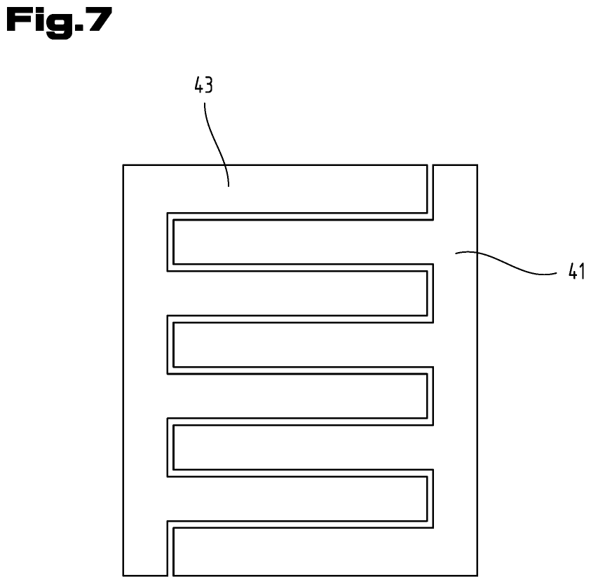

FIG. 7 schematically shows a possible arrangement of thermo controlled elements.

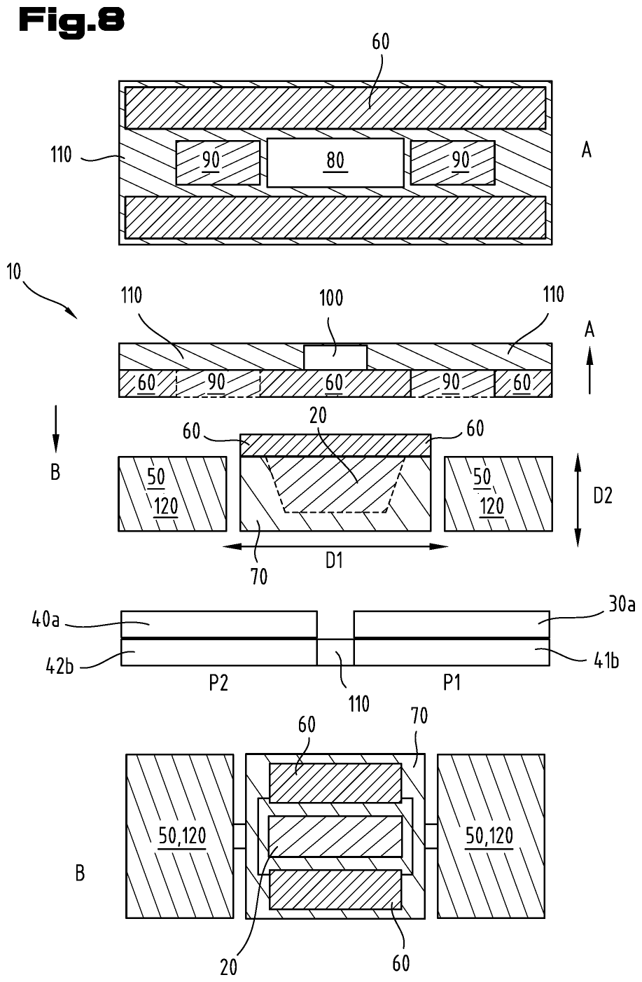

FIG. 8 schematically shows a seventh embodiment of the present application.

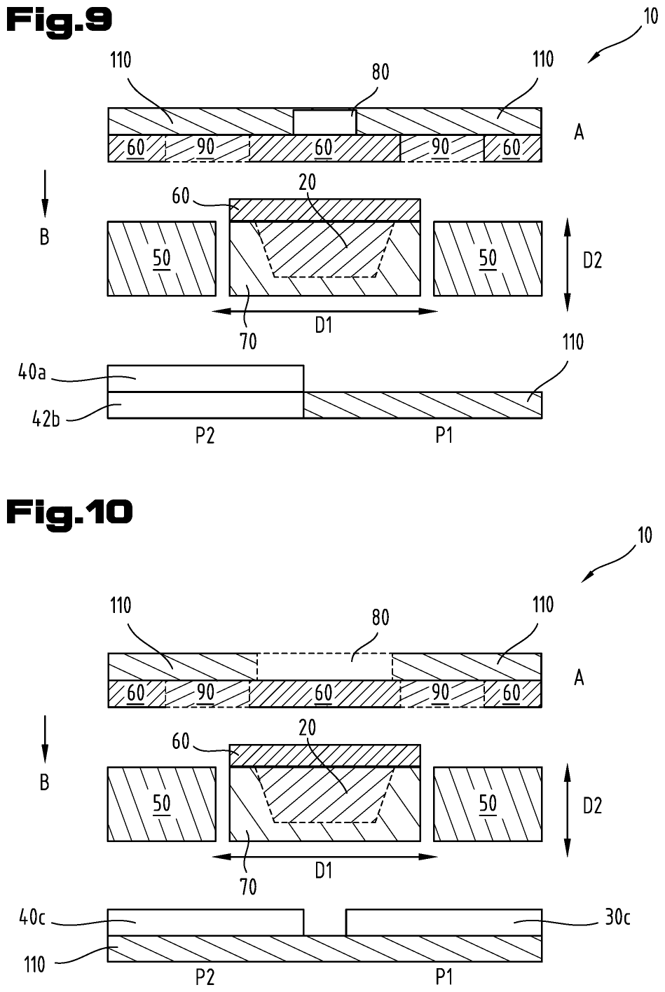

FIGS. 9 and 10 schematically show variations of the embodiment of FIG. 8.

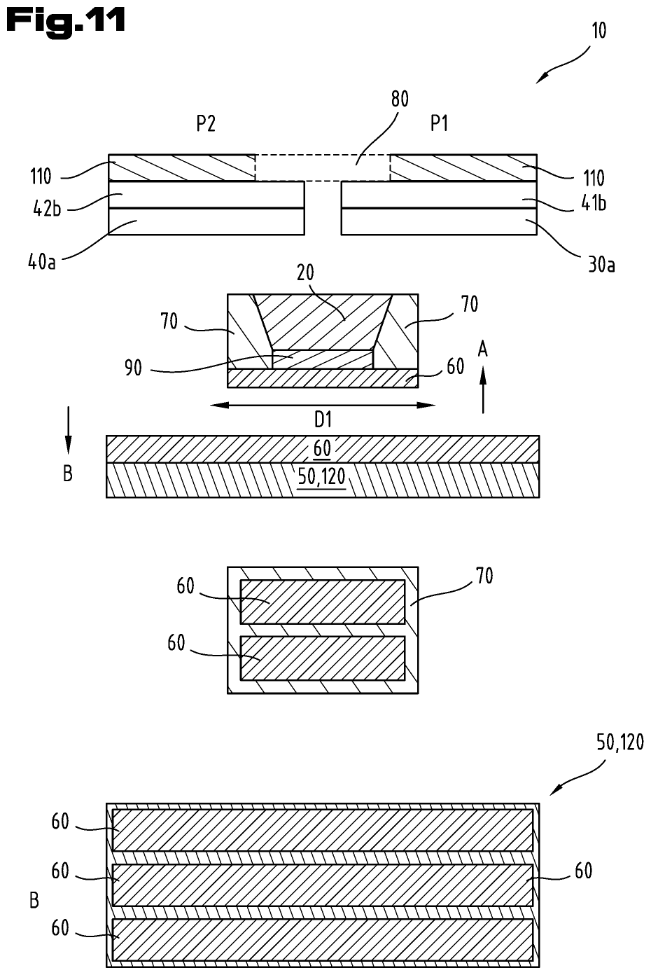

FIG. 11 schematically shows an eighth embodiment of the present application.

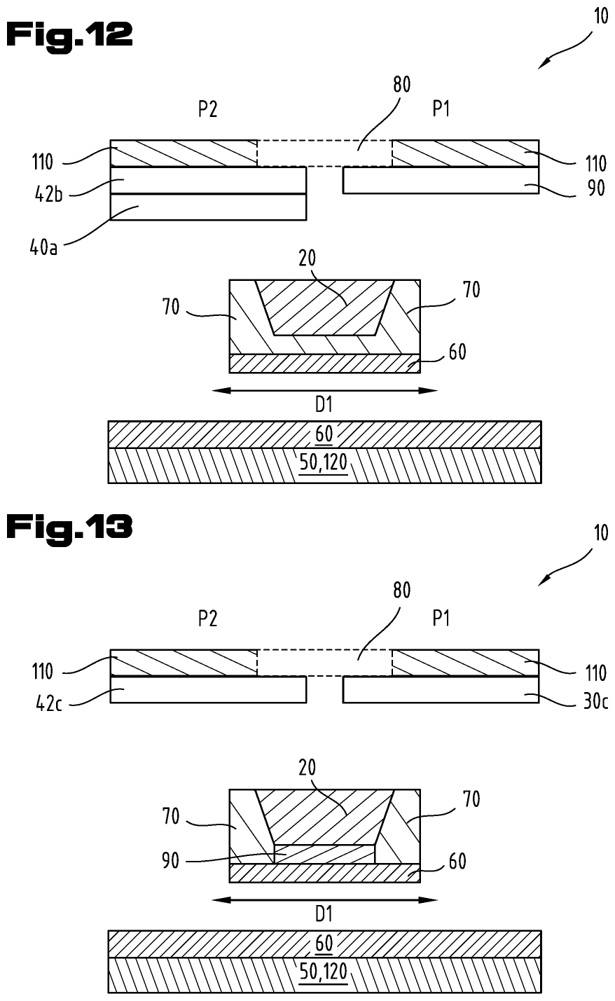

FIGS. 12 and 13 schematically show variations of the embodiment of FIG. 11.

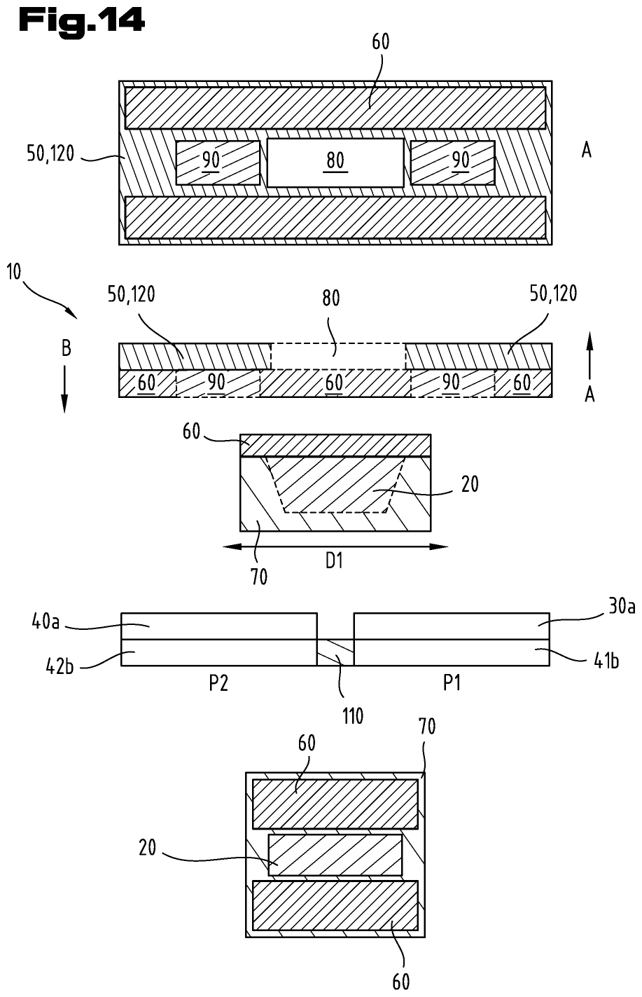

FIG. 14 schematically shows a ninth embodiment of the present application.

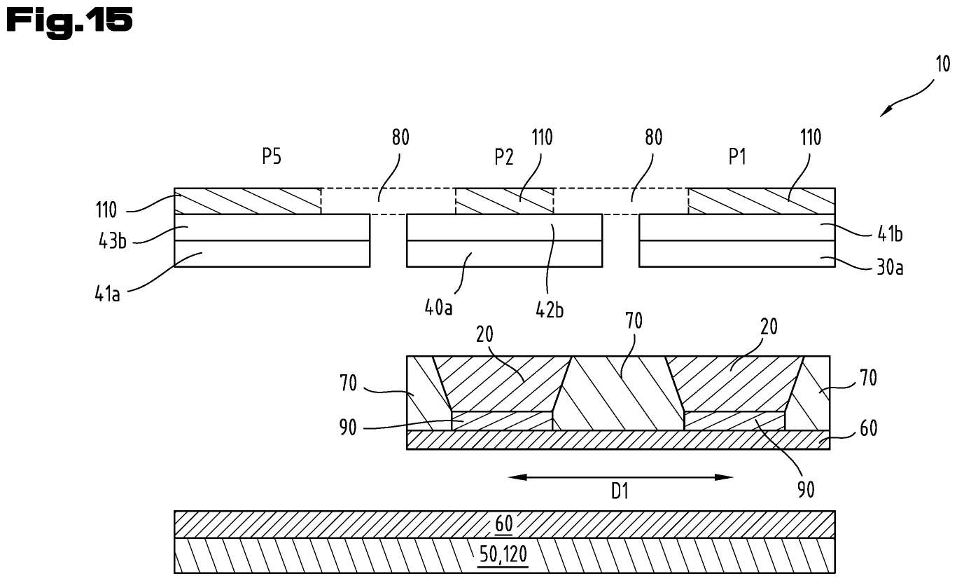

FIG. 15 schematically shows a tenth embodiment of the present application.

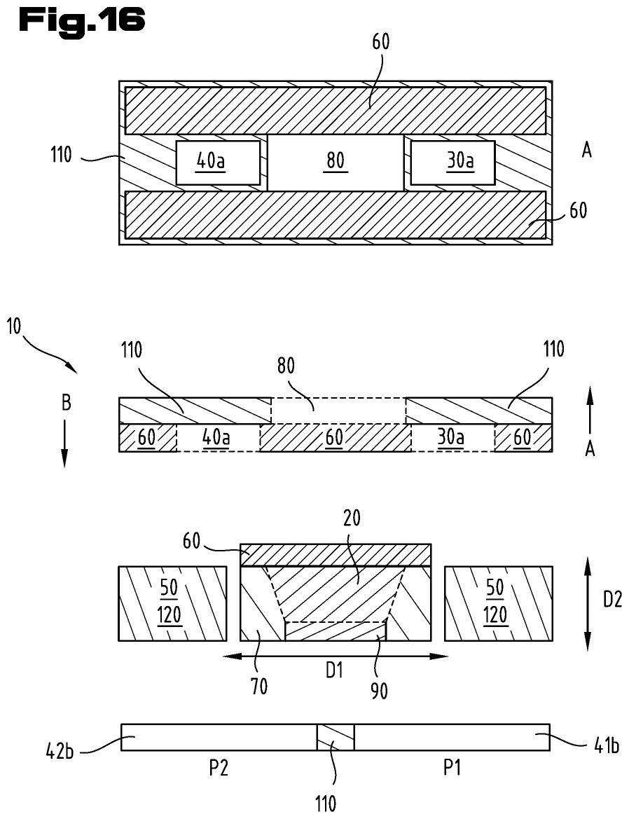

FIG. 16 schematically shows an eleventh embodiment of the present application.

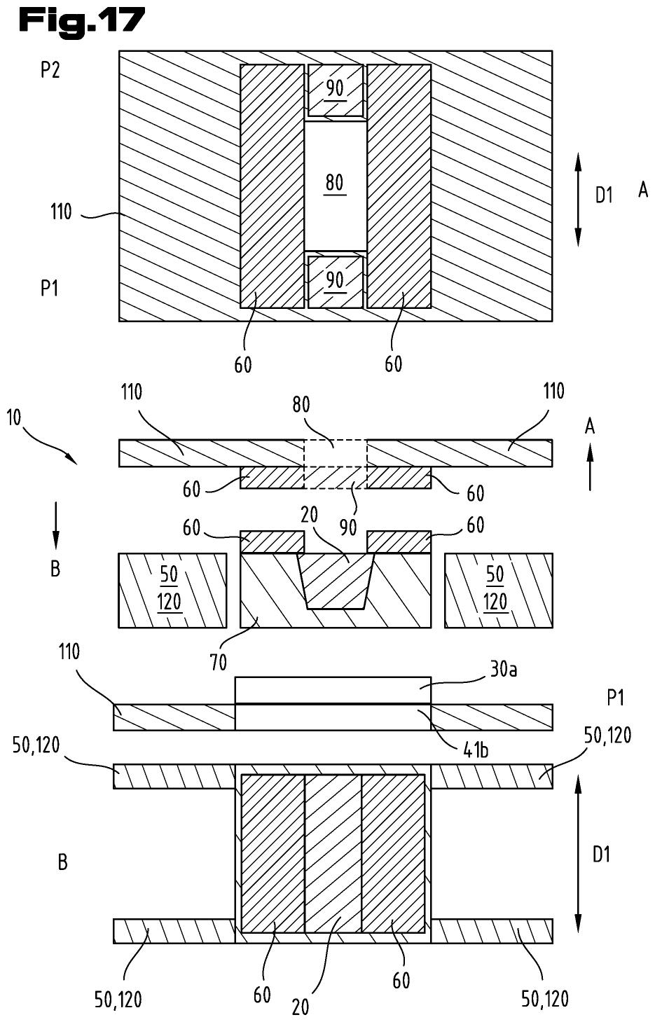

FIG. 17 schematically shows a twelfth embodiment of the present application.

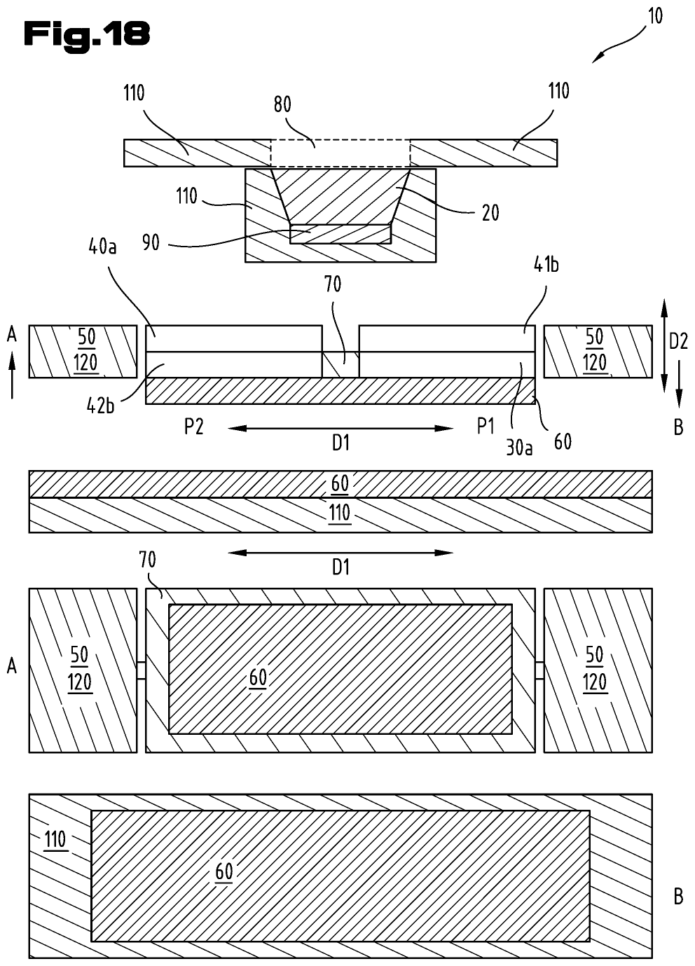

FIG. 18 schematically shows a thirteenth embodiment of the present application.

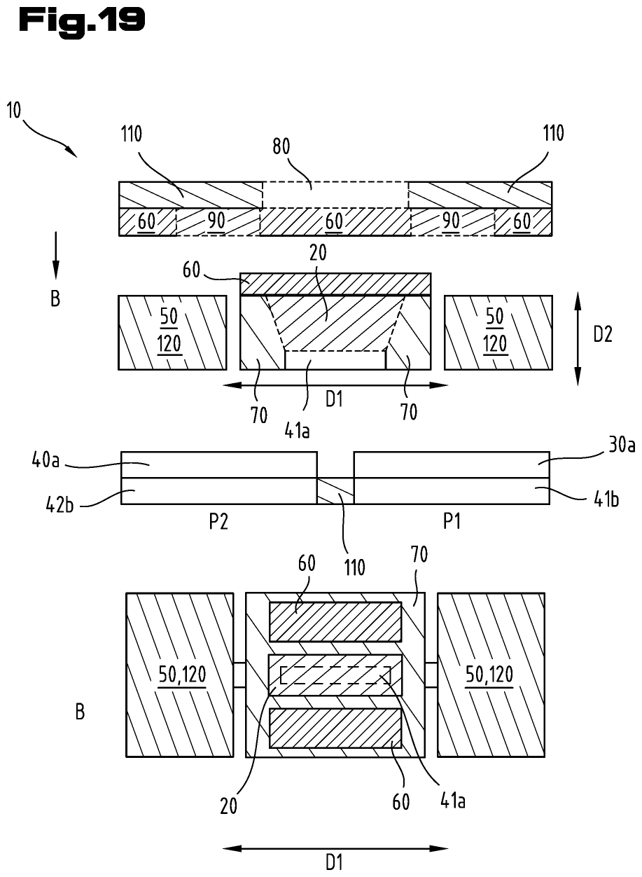

FIG. 19 schematically shows a fourteenth embodiment of the present application.

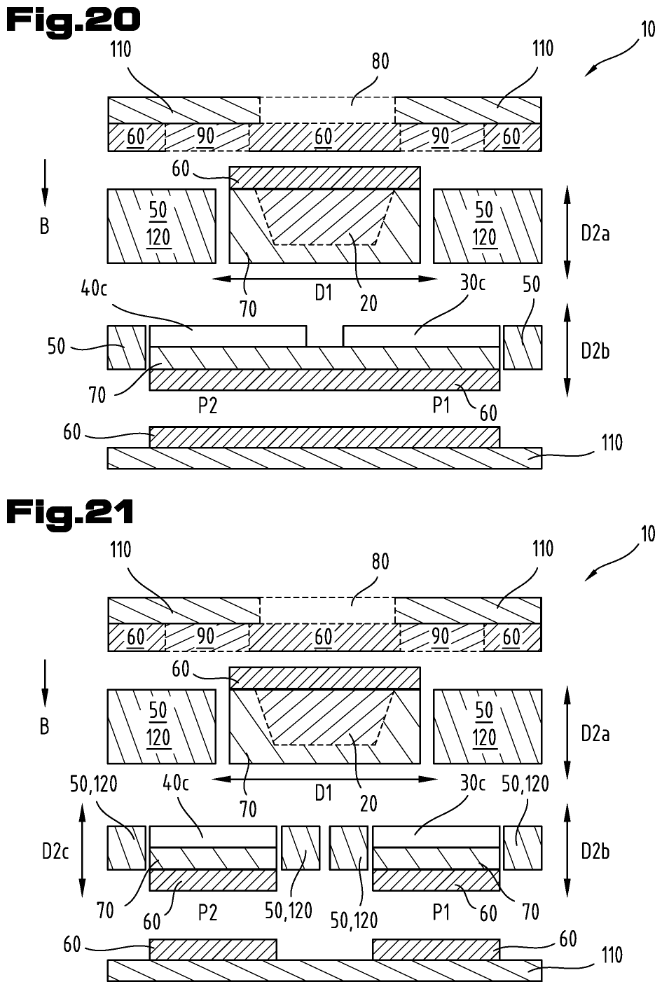

FIG. 20 schematically shows a fifteenth embodiment of the present application.

FIG. 21 schematically shows a sixteenth embodiment of the present application.

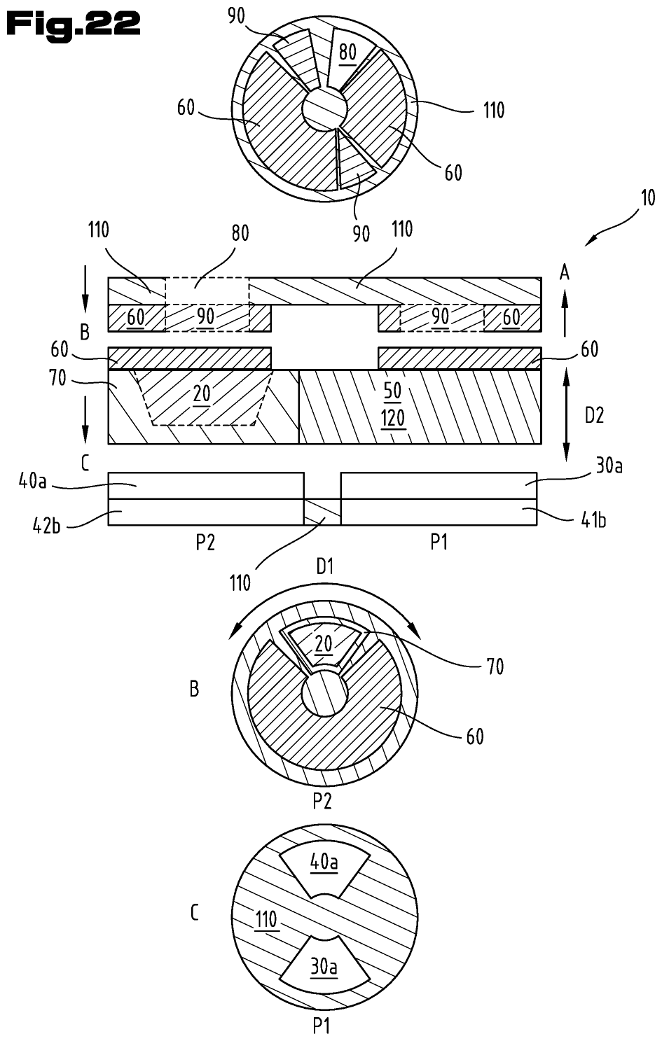

FIG. 22 schematically shows a seventeenth embodiment of the present application.

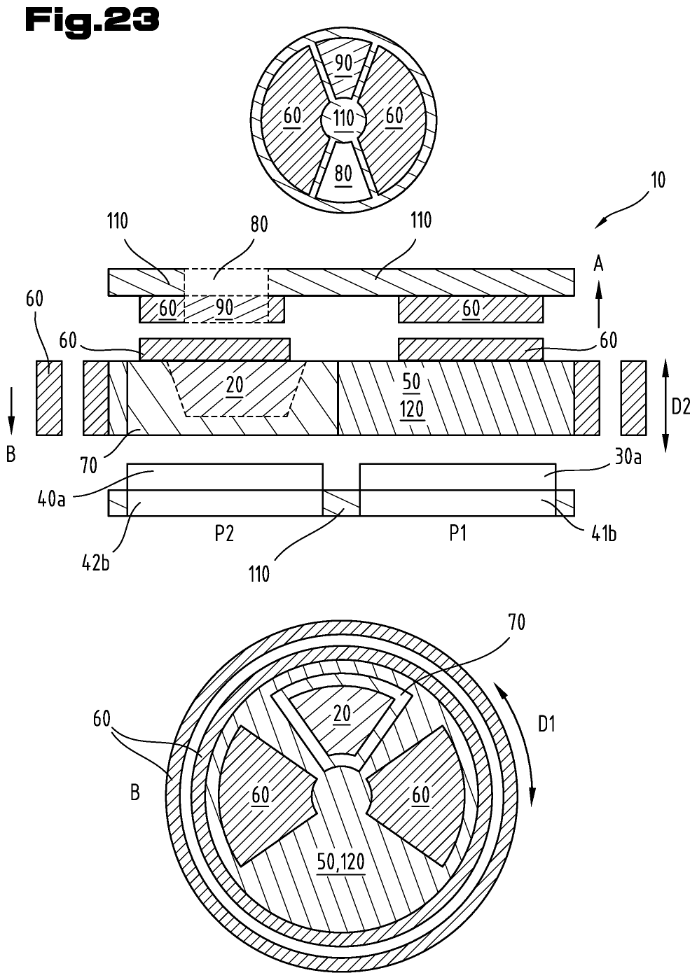

FIG. 23 schematically shows an eighteenth embodiment of the present application.

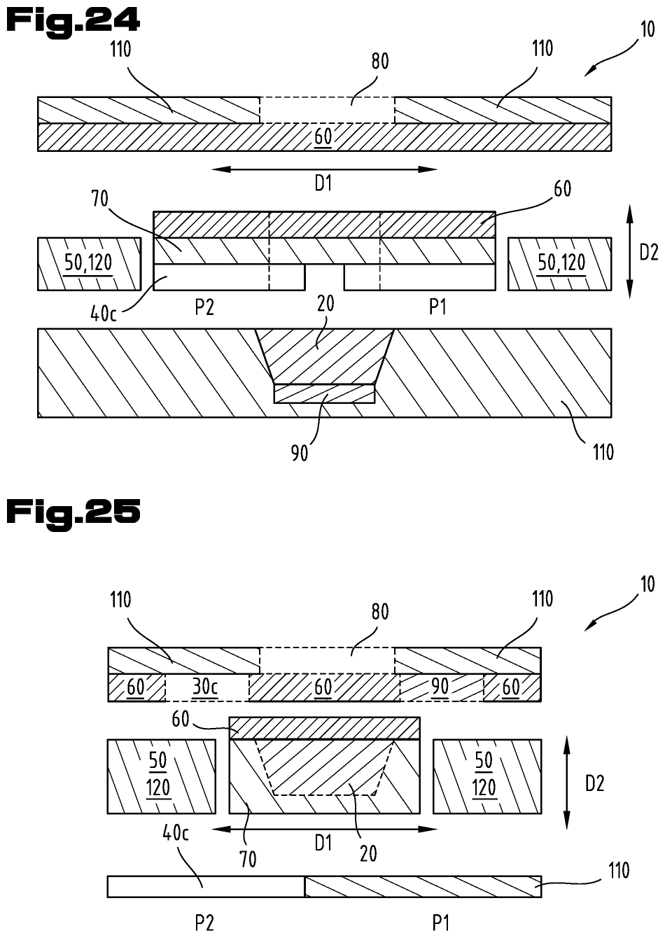

FIG. 24 schematically shows a nineteenth embodiment of the present application.

FIG. 25 schematically shows a twentieth embodiment of the present application.

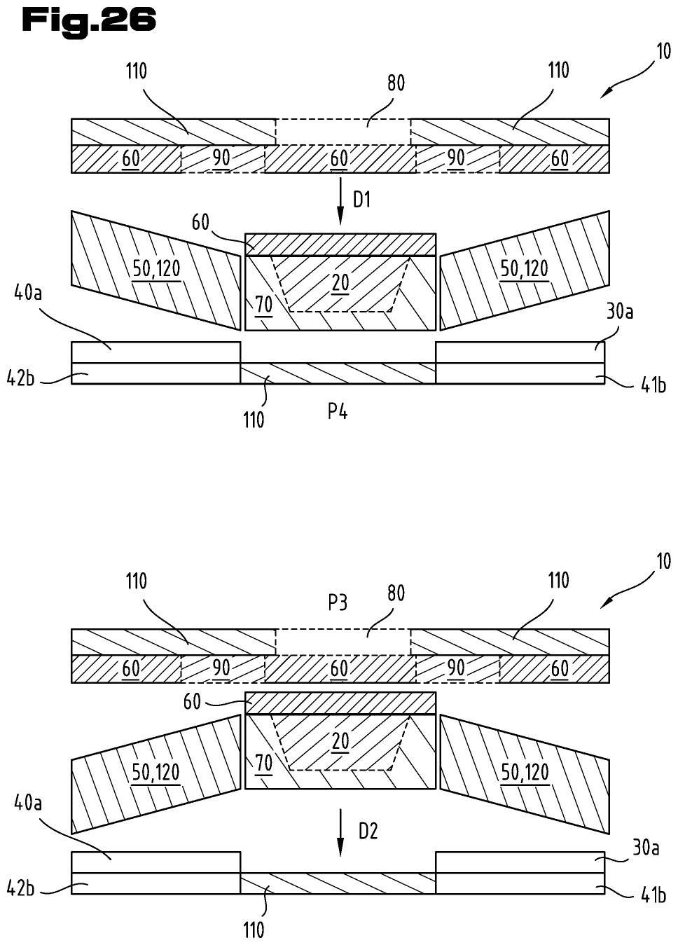

FIG. 26 schematically shows a movement in a second direction in detail.

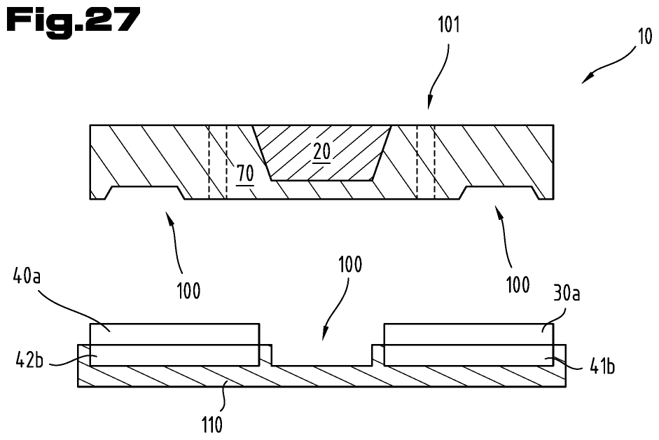

FIG. 27 schematically shows examples of grooves and cavities applied to elements of the micro-thermocycler.

It is to be noted that in the different embodiments described herein same parts/elements are numbered with same reference signs, however, the disclosure in the detailed description may be applied to all parts/elements having the regarding reference signs. Also, the directional terms/position indicating terms chosen in this description like up, upper, down, lower downwards, lateral, sideward are referring to the directly described figure and may correspondingly be applied to the new position after a change in position or another depicted position in another figure.

### DETAILED DESCRIPTION OF THE FIGURES

Initially referring to FIG. 1 a first embodiment of the present invention is schematically depicted. A micro-thermocycler 10 comprises a first thermo-controlled element 30 and a displacement unit 70 that in turn comprises a micro-reservoir 20. In the depicted embodiment the displacement unit 70 and the micro-reservoir 20 are unitary. However, the displacement unit 70 may comprise more than just one micro-reservoir 20 (see below, this is applicable to all embodiments). The micro-reservoir 20 is movable or displaceable by an actuating means 60 (not shown) from a first position P1 along a first direction D1 to a second position P2. For the following description of all embodiments a specific function of the thermo-controlled element(s) is explicitly stated otherwise they may heat or cool or both. In other words, if it is only referred to “thermo-controlled element(s)” they may heat or cool or both. The method steps are disclosed describing the function of the embodiments below.

In FIG. 1 the micro-reservoir 20 is depicted in the first position P1 in which the first thermo-controlled element 30 can thermally act on the micro-reservoir 20 and thus on a content (e.g. a sample) in the micro-reservoir 20. The first thermo-controlled element 30 may heat or cool the micro-reservoir 20. The first thermo-controlled element 30 is depicted as being parallel to a bottom of the micro-reservoir 20, however, the thermo-controlled element(s) is/are not limited thereto. The thermo-controlled element(s) may be for example oriented parallelly above or parallel to a side wall of the micro-reservoir, or above the top of a micro-reservoir 20. It is also understood that any depiction of the micro-reservoir above the thermal element may also be implemented with a similar structure but with the thermo-controlled element above the micro-reservoir.

The micro-reservoir 20 is movable along the first direction D1 from the first position P1 to the second position P2 (here depicted in dashed lines). In the second position only the ambient temperature acts on the micro-reservoir 20 and consequently cools the micro-reservoir 20 if it was heated in the first position P1 or heats the micro-reservoir 20 if it was cooled (below ambient temperature) in the first position P1. Here, the first and second position P1 and P2 are located in the same plane that also comprises the first direction D1. A plane in the sense of this application may be a plane that is parallel to a mentioned direction.

The second embodiment depicted in FIG. 2 is a variation of the first embodiment depicted in FIG. 1. The micro-thermocycler 10 according to the second embodiment further comprises a second thermo-controlled element 40 that is located in the second position P2. The micro-reservoir 20 can move between the two positions P1 and P2 and the thermo-controlled element that is in the position not being currently occupied by the micro-reservoir 20 can be pre-heated or pre-cooled according to the temperature the respective thermo-controlled element is supposed to have. In FIG. 2 the micro-reservoir 20 is located in the first position P1 and consequently the second thermo-controlled element 40 is not occupied and thus can be pre-heated or pre-cooled such that the second thermo-controlled element 40 already has the desired temperature when the micro-reservoir 20 is moved from the first to the second position. Then the first thermo-controlled element 30 can be pre-cooled or pre-heated.

The third embodiment depicted in FIG. 3 is a variation of the first and second embodiments depicted in FIGS. 1 and 2. With respect to the second embodiment, the third embodiment further comprises two more positions: a third position P3 and a fourth position P4. The depicted embodiment further comprises a second direction D2 in which the displacement unit 70 (here unitary with the micro-reservoir 20) is movable.

To reach the third position P3, the micro reservoir moves 20 moves parallel along the first direction D1 and also along the second direction D2. In the third position P3, a content or sample may be delivered into the micro-reservoir 20 by means of a connector port 80. To reach the fourth position P4, the micro-reservoir 20 moves parallel along the first direction D1 and also along the second direction D2, however, in this case in an opposite sense of the third position P3. The displacement unit 70/micro-reservoir 20 may be locked in the fourth position P4 e.g. if the micro-thermocycler needs to be transported. The thermo-controlled elements 30 and 40 are located on a common plane that also includes the first direction D1. However, the first and second positions P1 and P2 may be located differently, such that for example the displacement unit 70/micro-reservoir 20 needs to move in both directions D1 and D2 in order to reach one of them or both.

The fourth embodiment depicted in FIG. 4 is a variation of the third embodiment depicted in FIG. 3. Here, two more positions, a fifth P5 and sixth position P6 are further comprised by the micro-thermocycler 10. Further, a third thermo controlled element 41 is located in the fifth position P5 and a fourth thermo controlled element 42 is located in the sixth position P6. In the embodiment of FIG. 4 the first, second, fifth and sixth positions P1, P2, P5 and P6 are only reachable if the micro-reservoir 20 (here also being unitary with the displacement unit 70) is moved in both directions D1 and D2. In comparison, in the third embodiment, the thermo-controlled elements 30 and 40 are located on a common plane that also includes the first direction D1. In the fourth embodiment depicted in FIG. 4, the first, second and third position P1, P2 and P3 are located on the same plane and the fourth, fifth and sixth positions P4, P5 and P6 are also located on another but common plane. However, any distribution of the positions on respective planes are possible.

In the fourth embodiment, there is the possibility to pre-heat or pre-cool the thermo-controlled elements not occupied by the displacement unit 70. Also, it is possible that two elements heat or cool the displacement unit 70/micro-reservoir 20 at the same time or position, e.g. the first and third thermo-controlled elements 30 and 41 in the first or fifth position P1 or P5 if a distance between the regarding thermo-controlled elements is set accordingly. It is also possible to have one position and one thermo-controlled element less in the fourth embodiment.

The fifth embodiment depicted in FIG. 5 is similar to the second embodiment depicted in FIG. 2. The micro-thermocycler 10 of FIG. 5, however, comprises four thermo-controlled elements 30a, 40a, 41b, 42b in two positions P1 and P2. Here, two thermo-controlled elements are stacked upon each other in each of both positions. The upper thermo-controlled elements in each position (closer to the micro-reservoir 20) are thermo-controlled heating elements 40a and 30a. The lower thermo-controlled elements in each position (further away from the micro-reservoir 20) are thermo-controlled cooling elements 41b and 42b. Thermo-controlled elements, however, can also be stacked in the other sense, such that the thermo-controlled element being closer to the micro-reservoir is a thermo-controlled cooling element (this is applicable to all embodiments). The thermo-controlled cooling elements 41b and 42b may be TEC-elements.

The sixth embodiment depicted in FIG. 6 is similar to the fourth embodiment depicted in FIG. 4 and the fifth embodiment depicted in FIG. 5. The micro-thermocycler 10 of FIG. 6 comprises six thermo-controlled elements 30, 40, 41a, 42a, 43b and 44b in four positions P1, P2, P5 and P6. Here, two thermo-controlled elements 41a, 42a, 43b and 44b are stacked upon each other in each of the positions P5 and P6. The upper thermo-controlled elements in each position (closer to the micro-reservoir 20) are thermo-controlled heating elements 41a and 42a. The lower thermo-controlled elements in each position (further away from the micro-reservoir 20) are thermo-controlled cooling elements 41b and 42b. The thermo-controlled cooling elements 41b and 42b may be TEC-elements. There are further thermo-controlled elements 30 and 40 in positions P1 and P2.

In FIG. 7 an interlocking arrangement of two thermo-controlled elements 41 and 43 is shown in a top view (e.g. through the bottom of a micro-reservoir). This arrangement is exemplary and may be applied to all embodiments e.g. where there are stacked thermo-controlled elements as for example in FIGS. 5 and 6. It is also possible that the thermo-controlled elements interlock not only in the same plane but also or only in another e.g. angled plane (vertically interlocked). The same interlocking arrangement is also possible for elements of the displacement actuating means 60 and or readout sensors 90.

In FIG. 8 a seventh embodiment is depicted in a sectional view that is similar to the fifth embodiment in FIG. 5. In the middle part of FIG. 8 the stacked or multiple surfaces of the micro-thermocycler 10 are shown. The micro-reservoir 20 is comprised in a displacement unit 70 and displacement actuating means 60 are located on an upper surface of the displacement unit 70 in two rows. A single row or more than two rows of (multiple) displacement actuation means 60 are also possible, and applies to all embodiments. Said rows are located on the side(s) of an opening of the micro-reservoir 20. The displacement unit 70 is movable in the directions D1 and D2. Above the displacement unit 70 there are further displacement actuating means 60 located along with readout sensors 90. The displacement actuating means 60 and the readout sensors 90 are positioned on a substrate 110 as support material. The substrate 110 comprises a connector port 80 in the middle, that is in a projection of the area where the stacked thermo-controlled elements 40a and 42b adjoin the stacked thermo-controlled elements 30a and 41b that are located beneath the displacement unit 70. The thermo-controlled elements 30a and 40a are thermo-controlled heating elements and the thermo-controlled elements 42b and 41b are thermo-controlled cooling elements.

Detail A in the upper part of FIG. 8 shows a plain view of the cross-sectional view in the middle part as indicated in direction A. The displacement actuating means 60 are disposed on the side(s) of the two readout sensors 90 corresponding to the placement of the displacement actuating means 60 on the displacement unit 70 such as to engage with said displacement actuating means 60. The displacement actuating means 60 and the readout sensors 90 are located on the substrate 110 comprising said connector port 80 with its opening oriented towards the opening of the micro-reservoir 20. The displacement actuating means 60 are spaced apart from each other along two rows. The two rows sandwich the readout sensors 90 and the connector port 80 as can be seen from detail A in FIG. 8.

Detail B in the lower part of FIG. 8 is a plain view of the cross-sectional view in the middle part as indicated in direction B. That is a plain view onto the upper surface of the displacement unit 70. Left and right of the micro-reservoir, the displacement unit 70 is coupled with retaining structures 50. Here, the retaining structure is a structure comprising micromechanical structures 120 in the form of springs. Said retaining structures 50 keep the micro-reservoir 20 centered in the micro-thermo cycler and thus beneath the connector port 80. Said displacement actuating means 60 located on the upper surface of the displacement unit 70 have the same orientation as the displacement actuating means 60 in detail A and can interact with them. Here, the displacement actuating means 60 are electrodes. If the displacement actuating means 60 are respectively controlled, the displacement unit 70 can be displaced against the forces of the retaining structures 50 along the first direction D1 into the positions P1 and P2 where the thermo-controlled elements 30a, 40a, 41b and 42b can thermally act on the micro-reservoir 20 that is then positioned above the respective thermo-controlled elements (at least partially overlapping). Further, the micro-reservoir 20 may be displaced by means of the displacement actuating means 60 along the second direction D2 towards the thermo-controlled elements 30a, 40a, 41b and 42b and/or the readout sensors 90. Between the displacement actuating means 60 of detail B there is the opening of the micro-reservoir 20 that can receive a sample and/or reaction material from the connector port 80. The thermo-controlled elements 30a, 40a, 41b and 42b are also located on a substrate 110.

In FIG. 9 a variation of the seventh embodiment is depicted in a sectional view that is similar to FIG. 8. Other than in FIG. 8, there are only two stacked thermo-controlled elements 40a and 42b in position P2. The thermo-controlled elements 40a and 42b are also located on a substrate 110.

In FIG. 10 a variation of the seventh embodiment is depicted in a sectional view that is similar to FIG. 8. Other than in FIG. 8, there are only two thermo-controlled elements 30c and 40c, in positions P1 and P2. Said two thermo-controlled elements 30c and 40c are combined thermo-controlled elements that can be used to heat or cool the micro-reservoir. Said thermo-controlled elements are located on a substrate 110.

In FIG. 11 an eighth embodiment is depicted in a sectional view that is similar in its set-up to FIG. 8. In FIG. 11 the upper part also depicts a cross-sectional view of the micro-thermocycler 10. Here, the micro-reservoir 20 comprises a readout sensor 90 on an inner surface of the micro-reservoir 20 and displacement actuating means 60 on an underside of the displacement unit 70 that is oriented towards and mechanically coupled to a stationary retaining structure 50 (detail B) also comprising displacement actuating means 60 that engage with the displacement actuating means 60 located on the underside of the displacement unit 70. Here, the retaining structure comprises of micromechanical structures 120 in the form of rail guides. Here, the displacement actuating means 60 are electrodes. Above the micro-reservoir 20 there are four thermo-controlled elements 30a, 40a, 41b and 42b that are corresponding to the seventh embodiment. Respective activation of the displacement actuating means 60 displaces the micro-reservoir 20 along the first direction D1 to the positions P1 or P2.

In FIG. 12 a variation of the eight embodiment is depicted in a sectional view that is similar to FIG. 11. Other than in FIG. 11, there are only two stacked thermo-controlled elements 40a and 42b in position P2 and the readout sensor 90 in position P1 and not on the bottom of the micro-reservoir like in FIG. 11.

In FIG. 13 a variation of the eight embodiment is depicted in a sectional view that is similar to FIG. 11. Other than in FIG. 11, there are only thermo-controlled combined elements 30c and 42c in the positions P1 and P2.

In FIG. 14 a ninth embodiment is depicted in a sectional view that is similar in its set-up to FIG. 11. However, here the displacement unit 70 comprises displacement actuating means 60 on its upper surface along the opening of the micro-reservoir 20, and the thermo controlled heating elements 30a and 40a are located on a plane below the micro-reservoir 20 and located on a substrate 110. The displacement actuating means 60 on the upper surface of the displacement unit 70 engage with the displacement actuating means 60 in the upper part (shown in detail A). Here, the displacement actuating means 60 are electrodes. The displacement unit 70 is mechanically coupled to a stationary retaining structure 50 (shown in detail A). Here, the retaining structure comprises of micromechanical structures 120 in the form of rail guides.

Detail A in the upper part of FIG. 14 shows a plain view of the cross-sectional view in the middle part as indicated in direction A. The displacement actuating means 60 are disposed on the side(s) of the two readout sensors 90 such as to engage with the displacement actuating means 60 disposed on the upper surface of the displacement unit 70. The displacement actuating means 60 and the readout sensors 90 are located on the substrate 110 comprising said connector port 80 with its opening oriented towards the opening of the micro-reservoir 20. The displacement actuating means 60 are disposed adjacent to the readout sensors 90 and connector port 80, as can be seen from detail A in FIG. 14.

In FIG. 15 a tenth embodiment is depicted in a sectional view that is similar in its set-up to FIG. 11. However, here there are two micro-reservoirs 20 that are comprised in a displacement unit 70 having a displacement actuating means 60 on a bottom side and each micro-reservoir 20 comprises a readout sensor 90 on an inside surface of the micro-reservoir 20, corresponding to FIG. 11. Further there are three positions P1, P2 and P5 in this embodiment. Each position comprises two stacked thermo-controlled elements 30a and 41b in position P1, 40a and 42b in position P2 and 41a and 43b in position P5. The stacked thermo-controlled elements correspond to the thermo-controlled elements of FIG. 11, that is the thermo-controlled elements 30a, 40a and 41a closer to the micro-reservoirs 20 are thermo-controlled heating elements. The thermo-controlled elements 41b, 42b and 43b that are farther away from the micro-reservoirs 20 are thermo-controlled cooling elements. Each stack is also disposed on the substrate 110 that comprises the connector ports 80. Said connector ports 80 also extend into gaps between the stacked thermo-controlled elements. In this embodiment there is one displacement unit 70. Said displacement unit 70 is movable and comprises the micro-reservoirs 20 that in turn comprise each one readout sensor 90, and is mechanically coupled to a stationary retaining structure 50 that comprises displacement actuating means 60 that engage with the displacement actuating means 60 that is disposed beneath the movable displacement unit 70.

In FIG. 16 an eleventh embodiment is depicted in a sectional view that is similar in its set-up to FIG. 8. However, here the thermo-controlled heating elements 30a and 40a are disposed between the two rows of displacement actuating means 60 in detail A. Accordingly, the readout sensor 90 is located in the micro-reservoir 20. Beneath the micro-reservoir, there are two thermo-controlled cooling elements 41b and 42b located. The remaining features of the micro-thermocycler in FIG. 16 correspond to FIG. 8.

In FIG. 17 a twelfth embodiment is depicted in a sectional view that is similar in its set-up to FIG. 8. However, here the movement is different from the embodiment in FIG. 8. The micro-reservoir 20 moves along the first direction D1 as indicated in the upper (detail A) and lower (detail B) section of FIG. 17. That is into and out of the plane of projection in the middle part of FIG. 17. In the middle part the micro-thermocycler 10 is depicted in the first position P1 as also indicated in the upper section of FIG. 17. Mutandis mutatis to FIG. 8 there are two stacked thermo-controlled elements 30a and 41b in position P1 as well as 40a and 42b in position P2 (not shown in FIG. 17 as P2 lies into the projection plane). The retaining structure 50 that comprises the displacement unit 70 also comprises micro-mechanical structures 120. Here, the micro-mechanical structures 120 are flexible beams. The beams are located at each corner of the micro-reservoir 20 (see detail B) and may also be located at other positions in between the ends. The setup of detail A is essentially the same as in fig.

In FIG. 18 a thirteenth embodiment is depicted in a sectional view. Here, the micro-reservoir 20 is stationary overlapping the connector port 80 and is comprised in a substrate 110. Said substrate is coupled to the substrate 110 comprising the connector port 80. The micro-reservoir 20 comprises a readout sensor 90. The connector port 80 is located on the substrate 110 in the middle and above the micro-reservoir 20. A retaining structure 50 comprises the displacement unit 70 and micro-mechanical structures 120 (springs as in FIG. 8). The displacement unit 70 comprises four stacked thermo-controlled elements 30a, 40a, 41b and 42b and displacement actuating means 60. The thermo-controlled elements are stacked in two positions P1 and P2. The displacement actuating means 60 span the two stacks of thermo-controlled elements and are located on a substrate 110 (see detail A). The displacement actuating means 60 comprised by the displacement unit 70 are arranged parallel to the first direction D1 such that the displacement unit 70 is movable between the two positions P1 and P2. As described above, the thermo-controlled elements that are aligned with the micro-reservoir 20 in the respective position can thermally act on the micro-reservoir 20. Beneath the movable displacement unit 70 there are further displacement actuating means 60 that are also are arranged parallel to the first direction D1 (see detail B), corresponding to the displacement actuating means 60 on the substrate 110. The retaining structure 50 and displacement actuation means 60 may here also be implemented in such a method similar to FIG. 11, that is with a rail guide structure instead of said springs.

In FIG. 19 a fourteenth embodiment is depicted in a sectional view that is similar in its set-up to FIG. 8. However, here in contrast to FIG. 8 the micro-reservoir 20 comprises a thermo-controlled heating element 41a on an inside surface of the micro-reservoir.

In FIG. 20 a fifteenth embodiment is depicted in a sectional view that is similar in its set-up to FIG. 8. However, here there are two movable displacement units 70. One displacement unit 70 comprises the micro-reservoir 20 and is coupled with the retaining structures 50 and micro-mechanical structures 120 (springs) (corresponding to FIG. 8), and the other displacement unit 70 comprises the thermo-controlled combined elements 30c, 40c, and is coupled with micro-mechanical structures 120. Consequently, the displacement unit 70 with the micro-reservoir 20 may move in the first direction D1 between the positions P1 and P2 and in a second first partial direction D2a. Correspondingly, the displacement unit 70 comprising the thermo-controlled combined elements 30c and 40c also in the first direction D1 between the positions P1 and P2 and in a second second partial direction D2b. The partial directions D2a and D2b are like the second direction D2 perpendicular to the first direction D1.

In FIG. 21 a sixteenth embodiment is depicted in a sectional view that is similar in its set-up to FIG. 20. The difference here to FIG. 20 is that the thermo-controlled combined elements 30c as well as 40c are each comprised by a separate displacement unit 70 that is also coupled to separate retaining structures 50 and displacement actuating means 60. Accordingly, the two displacement units 70 are movable in the first direction D1 and in a second second partial direction D2b and a second third partial direction D2c. Further, for each of the separate displacement actuating means 60 of the displacement units 70 comprising the thermo-controlled combined elements, there are separate displacement actuating means 60 located beneath on the substrate 110 (see FIG. 21 below P1 and P2).

In FIG. 22 a seventeenth embodiment is depicted in a sectional view. Here, the movement of the displacement unit 70 comprising the micro-reservoir 20 is a rotational movement. The micro-thermocycler is built up having three different discs stacked upon each other (details A, B and C). Detail A is corresponding to e.g. detail A of FIG. 8. Here as well, a substrate 110 supports multiple displacement actuating means 60 being an array of electrodes that are arranged in a circular pattern on the substrate 110. The substrate further comprises two read out sensors 90 and a connector port 80. The readout sensors 90 and the connector port are arranged in any empty spaces between or around the displacement actuating means 60. The retaining structure 50 comprises the displacement unit 70 that in turn comprises the micro-reservoir 20 as well as the displacement actuating means 60 that is arranged in a circular pattern on the retaining structure 50, corresponding to the displacement actuating means 60 of detail A. The micro-reservoir 20 is also arranged in an empty sector of the displacement unit 70.

The first direction D1 is a rotational movement around the center of the disc shaped retaining structure 50 comprising the displacement unit 70. Further, the second direction D2 is parallel to the rotational axis (perpendicular to the projection plane of FIG. 22) of the displacement unit 70 and retaining structure 50. The displacement unit 70 can move parallel to the second direction D2 towards the readout sensors 90 or towards the thermo-controlled elements. The thermo-controlled elements 30a, 40ak, 41b and 42b are also stacked in pairs like described above. Here, the thermo-controlled elements 30a, 40a, 41b and 42b are arranged corresponding to the micro-reservoir 20 on which they are supposed to thermally act. In detail C (which is like details A and B a top view of the respective disc) only the thermo-controlled heated elements 30a and 40a are visible since the thermo-controlled cooling elements 41b and 42b are located below said thermo-controlled heated elements 30a and 40a and thus within the projection plane of detail C in FIG. 22. By controlling the displacement actuating means 60, the displacement unit 70 can be rotated such that the micro-reservoir 20 aligns with the stacked thermo-controlled elements in the first position P1 or the second position P2. Further, the displacement unit 70 can be moved towards the readout sensors 90 or towards the thermo-controlled elements along the second direction D2. It is understood that variations of this embodiment may be also implemented with different numbers of retaining structures, thermo-controlled elements, displacement units, displacement actuating means, positions, sensors, and micro-reservoirs.

In FIG. 23 an eighteenth embodiment is depicted in a sectional view similar to FIG. 22. Here, there is only one read out sensor 90 that is located in detail A. However, the retaining structure 50 and the displacement unit 70 have circular and concentric displacement actuating means 60. With an additional displacement actuating means 60 on the retaining structure 50, corresponding to the displacement actuating means 60 of detail A, the micro-reservoir 20 is additionally movable in a direction D2, that is towards or away from the readout sensor 90.

In FIG. 24 a nineteenth embodiment is depicted in a sectional view similar to FIG. 18. Here, also the stacked thermo-controlled elements are located on a movable displacement unit 70 comprising displacement actuating means 60 and coupled with retaining structures 50. The micro thermo-cycler 10 also comprises a stationary micro-reservoir 20 that is located on a substrate 110 and comprises a readout sensor 90. However, the micro-reservoir is arranged on the bottom part of FIG. 24. To access the micro-reservoir 20 from the connector port 80 the displacement unit 70 needs to be between positions P1 and P2 such that matter (e.g. liquids) can traverse the displacement unit 70 and reach the micro-reservoir 20. Of course, the position to access the micro-reservoir 20 via the connector port (P3) may be different from the depicted middle position and may be achieved by means of a groove 101 in the displacement unit 70 that reaches traverse the displacement unit 70 and all structures it comprises.

In FIG. 25 a twentieth embodiment is depicted in a sectional view similar to FIG. 9. Here, the thermo controlled combined element 30c is located to the left of detail A and a readout sensor 90 is located to the right of detail A. Further, the thermo controlled combined element 40c is located on a substrate 110 on the bottom of FIG. 25. The remaining features and setup are mutatis mutandis to FIGS. 8 and 9.

FIG. 26 depicts the movement of the displacement unit 70 by means of the displacement actuating means 60 and the retaining structures 50 and micro-mechanical structures 120 in the direction D2 in particular. The setup may be the one of FIG. 8 for example. In the upper part of FIG. 26 the micro-reservoir 20 is located at the bottom and close to (even maybe touching or fixed to) the substrate 110 comprising the stacked thermo-controlled elements. In said position the micro-reservoir 20 is in a transport position P4 of the micro-thermo cycler 10.

The lower part of FIG. 26 depicts the micro-reservoir 20 in an upper position close to the connector port 80 such that matter can be transferred to or from the micro-reservoir. The upper position of the micro-reservoir 20 is a loading position P3 of the micro-thermo cycler 10. FIG. 26 complements FIGS. 3 and 4 and at least one of the positions P3 or P4 can be implemented in any micro-thermocycler 10 that is movable in D2.

FIG. 27 schematically shows the implementation of grooves 101 and/or cavities 100. A groove 101 is a trough hole traverse a structure (e.g. the displacement unit 70). A cavity 100 is a depression in a surface. Both, grooves 101 and cavities 100 may be used to thermally decouple elements of the micro-thermocycler. Further, grooves 101 may be used to access areas of the micro-thermocycler in certain positions (e.g. to access the micro-reservoir 20 from the connector port 80). The grooves 101 and cavities 100 may be applied to all embodiments and elements (depicted are displacement unit 70 and substrate 110, however, they may also be applied to the thermo controlled elements, the micro-reservoirs, the displacement actuating means, the retaining structures, the readout sensors, the micro-mechanical structures) in any number or position necessary or desired.

The embodiments depict possible variations of carrying out the invention, however, it is to be noted that the invention is not limited to the depicted embodiments/variations but numerous combinations of the here described embodiments/variations are possible and these combinations lie in the field of the skills of the person skilled in the art being motivated by this description. For example, at each location of one read out sensor 90, there may be multiple readout sensors 90 in any configuration combination (e.g. in the micro-reservoir or the structures in details A). It is understood that variations of the embodiments may be also implemented with different numbers of retaining structures, thermo-controlled elements, displacement units, displacement actuating means, positions, sensors, and micro-reservoirs. The thermo controlled element(s) and/or readout sensor(s) may be arranged in any position needed and/or desired. For example, the thermo controlled element(s) and/or readout sensor(s) may be arranged in at least one sidewall of the micro-reservoir. Further, the thermo-controlled element(s) are depicted as to be horizontal in the above embodiments and figs. However, the thermo-controlled element(s) may be arranged vertically.

The scope of protection is determined by the appended claims. The description and drawings, however, are to be considered when interpreting the claims. Single features or feature combinations of the described and/or depicted features may represent independent inventive solutions. The object of the independent solutions may be found in the description.

All notations of ranges of values in the present description are to be understood as to also comprise and disclose all arbitrary sub-ranges therein, e.g. the disclosure 1 to 10 is to be understood that all sub-ranges starting from the lower limit 1 up to the upper limit 10 are also comprised and disclosed, i.e. all sub-ranges starting with a lower limit of 1 or bigger and end with an upper limit of 10 or smaller, e.g. 1 to 1,7, or 3,2 to 8,1, or 5,5 to 10. Only one digit after the comma is described, however the same applies mutates mutandis to any given number of digits after the comma. It is further to be noted that for a better understanding parts/elements are depicted to some extent not to scale and/or enlarged and/or down scaled.

### REFERENCE SIGN LIST

10 micro-thermocycler
20 micro-reservoir(s)
30 thermo controlled element
40 second thermo controlled element
41 third thermo controlled element
42 fourth thermo controlled element
30a, 40a, 41a, 42a thermo controlled heating element
30b, 40b, 41b, 42b, 43b, 44b thermo controlled cooling element
30c, 40c, 41c, 42c thermo controlled combined element
50 retaining structure
60 displacement actuating means
70 displacement unit
80 connector port
90 readout sensor(s)
100 cavity
101 groove
110 substrate
120 micro-mechanical structure
P1 first position
P2 second position
P3 third position (loading position)
P4 fourth position (locking or transport position)
P5 fifth position
P6 sixth position
D1 first direction
D2 second direction
D2a second first partial direction
D2b second second partial direction
D2c second third partial direction

1. Micro-thermocycler (10), comprising at least one micro-reservoir (20), at least one thermo controlled element (30), at least one displacement unit (70) and at least one displacement actuating means (60), wherein the at least one displacement unit (70) comprises either the at least one micro-reservoir or the at least one thermo controlled element(s), and wherein the at least one displacement unit (70) can be displaced by means of the displacement actuating means (60) from a first position (P1) along a first direction (D1) to a second position (P2), and wherein the at least one thermo controlled element thermally acts on the at least one micro-reservoir in the first position and wherein the displacement actuating means operatively couple(s) the at least one displacement unit (70) and the other of thermo controlled element(s) or the micro-reservoir(s).

2. Micro-thermocycler (10) according to claim 1, further comprising a second thermo controlled element (40), and wherein the second thermo controlled element (40) thermally acts on the at least one micro-reservoir in the first (P1) or second position (P2).

3. Micro-thermocycler (10) according to claim 1, further comprising at least one retaining structure (50), wherein the at least one retaining structure retains the at least one displacement unit (70) and comprises at least one micro-mechanical structure (120).

4. Micro-thermocycler (10) according to claim 1, further comprising a third position (P3) and/or a fourth position (P4), wherein in the third position the at least one micro-reservoir (20) is accessible via at least one connector port (80), allowing matter to be transferred to or from the micro-reservoir(s) and wherein the fourth position is a transport position of the displacement unit(s).

5. Micro-thermocycler (10) according to claim 1, further comprising at least one readout sensor (90) that is adapted to sense a content of the at least one micro-reservoir (20) and wherein the at least one readout sensor is located internal to the at least one micro-reservoir or at a defined position external to the micro-reservoir(s), and where the contents of the micro-reservoir(s) is/are detectable by displacement of the micro-reservoir(s) and/or the at least one readout sensor.

6. Micro-thermocycler (10) according to claim 1, wherein the at least one displacement unit (70) is displaceable in a second direction (D2) being different to the first direction (D1) and the different positions are reachable by displacement of the at least one displacement unit (70) in at least one of the directions (D1, D2).

7. Micro-thermocycler (10) according to claim 1, wherein the at least one displacement unit (70) is lockable in at least one of the positions.

8. Micro-thermocycler (10) according to claim 1, wherein the micro-thermocycler (10) is a flat three-dimensional structure, that comprises one or multiple surfaces, wherein the multiple surfaces are stacked surfaces.

9. Micro-thermocycler (10) according to claim 1, wherein the displacement along at least one of the directions is a rotational and/or linear motion.

10. Micro-thermocycler (10) according to claim 1, further comprising at least one thermal sensor located internal and/or external to the micro-reservoir(s), being adapted to sense temperature(s) at specific locations within the micro-thermocycler.

11. Micro-thermocycler (10) according to claim 1, further comprising at least one position sensor, wherein the position sensor detects the position of the at least one displacement unit (70) within the micro-thermocycler.

12. Micro-thermocycler (10) according to claim 1, wherein at least one aperture is located in the vicinity of the thermo controlled element(s) and/or the at least one micro-reservoir (20) and wherein the at least one aperture is a cavity (100) and/or a groove (101).

13. Micro-thermocycler (10) according to claim 1, wherein the at least one micro-reservoir (20) further comprises an openable cap.

14. Micro-thermocycler (10) according to claim 1, wherein at least one of the micro-reservoir (20) and/or the thermo controlled element(s) comprise material coatings to improve thermal and/or reaction characteristics.

15. Micro-thermocycler (10) according to claim 1, wherein an inside of the at least one micro-reservoir (20) comprises at least one profiled surface.

16. Micro-thermocycler (10) according to claim 1, further comprising control and/or sensing signals that can be dynamically controlled and/or pre-programmed.

17. Reaction method comprising the steps of placing a sample and reaction materials into at least one micro-reservoir, moving the micro-reservoir from a first position to a second position, heating or cooling the sample at the positions according to a predetermined procedure.

18. Reaction method according to claim 17, wherein the position that is not occupied by the micro-reservoir(s) is/are pre-heated or pre-cooled.

19. Reaction method according to claim 17, wherein the properties of the sample may be detected continuously or at specific time points.

20. Reaction method according to claim 17, wherein the heating and/or cooling is cyclic.
